(19) United States
(12) Patent Application Publication
(10) Pub. No.: US 2025/0210859 A1
(43) Pub. Date: Jun. 26, 2025

(54) VECTOR DECOMPOSER, OPTICAL RADIO TRANSMISSION SYSTEM, AND VECTOR DECOMPOSITION METHOD

(71) Applicant: NEC Corporation, Tokyo (JP)

(72) Inventors: Shinichi HORI, Tokyo (JP); Yuma KASE, Tokyo (JP)

(73) Assignee: NEC Corporation, Tokyo (JP)

(21) Appl. No.: 18/969,511

(22) Filed: Dec. 5, 2024

(30) Foreign Application Priority Data
Dec. 21, 2023 (JP) 2023-215683

(51) Int. Cl. H01Q 3/28

(52) U.S. Cl. CPC H01Q 3/28

(57) ABSTRACT

A vector decomposer includes: a phase rotation signal generator configured to generate a first phase rotation signal and a second phase rotation signal each having a phase rotated through 90° in a positive direction and a negative direction with respect to an input signal; and a combiner configured to combine the input signal and the first phase rotation signal and generate a first outphasing signal, and combine the input signal and the second phase rotation signal and generate a second outphasing signal.

### INCORPORATION BY REFERENCE

This application is based upon and claims the benefit of priority from Japanese patent application No. 2023-215683, filed on Dec. 21, 2023, the disclosure of which is incorporated herein in its entirety by reference.

### TECHNICAL FIELD

The present disclosure relates to a vector decomposer, an optical radio transmission system, a communication apparatus, and a vector decomposition method.

### BACKGROUND ART

In an access network of a mobile network, an optical radio transmission system using an optical fiber is disposed as a system that supplies a radio wave at a low cost in a fringe area such as in an underground shopping mall and in a building where a radio wave from an outdoor base station is hard to reach. The optical radio transmission system is also called a radio over fiber (RoF) system. The optical radio transmission system includes a base unit, and one or more remote units disposed in a fringe area. The base unit and the remote unit are connected to each other via an optical fiber. In the optical radio transmission system, the base unit is also called a radio unit, and the remote unit is also called a distributed antenna unit.

A digital RoF (DRoF) system and an analog RoF (ARoF) system are known as the optical radio transmission system. In the digital RoF system, a base unit converts a baseband signal from a parallel signal into a serial signal. The baseband signal that has been converted into the serial signal is converted from an electrical signal into an optical signal by using an electrical signal/optical signal (E/O) converter, and is transmitted to a remote unit by an optical fiber. The transmitted optical signal is converted from an optical signal into an electrical signal by using an optical signal/electrical signal (O/E) converter.

The remote unit converts the transmitted baseband signal from a serial signal into a parallel signal. Further, the remote unit converts, from a digital signal into an analog signal, the baseband signal that has been converted into the parallel signal, by using a digital analog converter (DAC). Furthermore, the remote unit converts, into a high frequency signal, the baseband signal that has been converted into the analog signal, by using a mixer circuit. The high frequency signal is supplied to an antenna via an amplifier and a band-pass filter, and the antenna emits the high frequency signal to a fringe area.

On the other hand, in the analog RoF system, the base unit converts a digital baseband signal into an analog signal by using the DAC, and converts, into a high frequency signal, the baseband signal that has been converted into the analog signal, by using the mixer circuit. The high frequency signal is converted from an electrical signal into an optical signal by using the E/O converter, and is transmitted to the remote unit by an optical fiber. The transmitted high frequency signal is converted from an optical signal into an electrical signal by using the O/E converter. In the remote unit, the high frequency signal is supplied to an antenna via an amplifier such as a power amplifier and a band-pass filter, and the antenna emits the high frequency signal to a fringe area.

When the digital RoF system and the analog RoF system are compared, each remote unit needs to include a serial/parallel (S/P) converter that converts a serial signal into a parallel signal in the digital RoF system. Further, each remote unit needs to be equipped with the DAC associated with a broadband signal. Thus, power consumption in each remote unit is large, and a cost also increases. In contrast, the remote unit does not require the DAC in the analog RoF system, and thus power consumption is small and a size can also be reduced. Meanwhile, the analog RoF system requires a high-cost optical transmitter/receiver having excellent linearity and including E/O converter and O/E converter in order to avoid signal deterioration due to distortion.

An RoF system using 1-bit outphasing modulation is known as an RoF system that can use a low-cost optical transmitter/receiver. As a related technique, Japanese Unexamined Patent Application Publication No. 2021-129167 discloses an optical radio transmission system using an outphasing signal. In the optical radio transmission system described in Japanese Unexamined Patent Application Publication No. 2021-129167, a transmission apparatus corresponding to a base unit generates one set of outphasing signals, and orthogonally converts the outphasing signals at an intermediate frequency. The one set of the outphasing signals that has been orthogonally modulated is converted from an electrical signal into an optical signal by an E/O converter. The optical signal is transmitted to a remote unit by using an optical fiber, and an O/E converter disposed on the remote unit side converts the optical signal into an electrical signal. The remote unit combines the one set of the outphasing signals, converts the combined signal into a high frequency signal, and emits the high frequency signal from an antenna.

In the optical radio transmission system described in Japanese Unexamined Patent Application Publication No. 2021-129167, an optical fiber transmits an optical signal represented as a pulse waveform. Since the pulse waveform is binary of high and low, an inexpensive general-purpose digital optical module can be used for the E/O converter and the O/E converter. In the optical radio transmission system described in Japanese Unexamined Patent Application Publication No. 2021-129167, an inexpensive general-purpose digital optical module can be adopted instead of an expensive dedicated analog optical module required in an analog RoF type, and a cost reduction can be achieved.

However, Japanese Unexamined Patent Application Publication No. 2021-129167 does not take signal transmission from a remote unit to a base unit into consideration. When signal transmission from a remote unit to a base unit is taken into consideration, the following steps need to be performed in order to convert a radio frequency signal received by an antenna into an outphasing signal.
(1) A signal received from an antenna is converted into a digital signal by using an analog digital converter (ADC).
(2) One set of outphasing signals is generated from the digital signal described above in a digital outphasing modulator.
(3) The one set of the outphasing signals is converted into an analog signal by using a DAC.

In the optical radio transmission system described in Japanese Unexamined Patent Application Publication No. 2021-129167, a remote unit needs to include an ADC and a DAC in addition to a digital outphasing modulator in order to transmit a signal from the remote unit to a base unit. In general, the ADC and the DAC have high power consumption. Thus, it is difficult to reduce power consumption of the remote unit. Further, when the remote unit includes the ADC and the DAC, a configuration of the remote unit is complicated, and a size reduction of the remote unit is difficult.

### SUMMARY

An example object of the present disclosure is to provide a vector decomposer, an optical radio transmission system, a communication apparatus, and a vector decomposition method that can generate one set of outphasing signals with a simple configuration.

A vector decomposer according to a first aspect of the present disclosure includes: a phase rotation signal generator configured to generate a first phase rotation signal and a second phase rotation signal each having a phase rotated through 90° in a positive direction and a negative direction with respect to an input signal; and a combiner configured to combine the input signal and the first phase rotation signal and generate a first outphasing signal, and combine the input signal and the second phase rotation signal and generate a second outphasing signal.

An optical radio transmission system according to a second aspect of the present disclosure includes: a base unit; and a remote unit connected to the base unit via an optical transmission path. The remote unit includes an antenna, a phase rotation signal generator configured to generate a first phase rotation signal and a second phase rotation signal each having a phase rotated through 90° in a positive direction and a negative direction with respect to an input signal being a reception signal received by using the antenna, and a combiner configured to combine the input signal and the first phase rotation signal and generate a first outphasing signal, and combine the input signal and the second phase rotation signal and generate a second outphasing signal. The base unit includes a combiner configured to combine the first outphasing signal and the second outphasing signal being received from the remote unit via the optical transmission path, and regenerate a signal corresponding to the reception signal, an analog digital converter configured to convert the regenerated signal from an analog signal into a digital signal, and a signal processing circuit configured to perform signal processing on the signal converted into the digital signal.

A communication apparatus according to a third aspect of the present disclosure includes: a vector decomposer including a phase rotation signal generator configured to generate a first phase rotation signal and a second phase rotation signal each having a phase rotated through 90° in a positive direction and a negative direction with respect to an input signal being a transmission signal, and a combiner configured to combine the input signal and the first phase rotation signal and generate a first outphasing signal, and combine the input signal and the second phase rotation signal and generate a second outphasing signal; a first amplifier and a second amplifier configured to amplify the first outphasing signal and the second outphasing signal, respectively; and a combiner configured to combine the amplified first outphasing signal and the amplified second outphasing signal.

A vector decomposition method according to a fourth aspect of the present disclosure includes: generating a first phase rotation signal and a second phase rotation signal each having a phase rotated through 90° in a positive direction and a negative direction with respect to an input signal; and combining the input signal and the first phase rotation signal and generating a first outphasing signal, and combining the input signal and the second phase rotation signal and generating a second outphasing signal.

The vector decomposer, the optical radio transmission system, the communication apparatus, and the vector decomposition method according to the present disclosure can generate one set of outphasing signals with a simple configuration.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a schematic configuration example of an optical radio transmission system according to the present disclosure;

FIG. 2 is a block diagram illustrating a schematic configuration example of a communication apparatus according to the present disclosure;

FIG. 3 is a block diagram illustrating a configuration example of a first optical radio transmission system according to the present disclosure;

FIG. 4 is a vector diagram illustrating S₁ₜ(t), S₂ₜ(t), and S_{org}(t);

FIG. 5 is a vector diagram illustrating an input signal Sᵢₙ and generated outphasing signals S₁ and S₂;

FIG. 6 is a block diagram illustrating a configuration example of an analog vector decomposer;

FIG. 7 is a vector diagram illustrating a generation process of an outphasing signal;

FIG. 8 is a vector diagram illustrating a relationship between the input signal Sᵢₙ and the outphasing signals S₁ and S₂;

FIG. 9 is a block diagram illustrating a configuration example of an amplitude adjuster;

FIG. 10 is a block diagram illustrating a configuration example of an amplitude square unit;

FIG. 11 is a block diagram illustrating a configuration example of an amplitude 0.5 power unit;

FIG. 12 is a block diagram illustrating a configuration example of a gain variable I-V converter;

FIG. 13 is a block diagram illustrating a configuration example of a phase rotator;

FIG. 14 is a block diagram illustrating another configuration example of the phase rotator;

FIG. 15 is a block diagram illustrating another configuration example of the analog vector decomposer according to the present disclosure;

FIG. 16 is a vector diagram illustrating an operation of the analog vector decomposer;

FIG. 17 is a block diagram illustrating a configuration example of a digital baseband unit included in a base unit;

FIG. 18 is a graph illustrating an input/output characteristic of a correction circuit;

FIG. 19 is a block diagram illustrating a configuration example of a second optical radio transmission system according to the present disclosure;

FIG. 20 is a block diagram illustrating a configuration example of a part of a transmission unit of the base unit;

FIG. 21 is a block diagram illustrating a configuration example of a radio communication apparatus including the analog vector decomposer; and

FIG. 22 is a block diagram illustrating a hardware configuration of a DSP.

### EXAMPLE EMBODIMENT

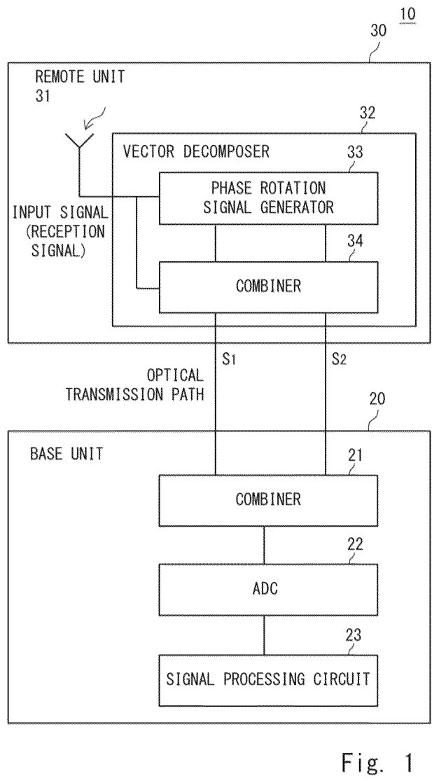

Prior to description of example embodiments of the present disclosure, an outline of the present disclosure will be described. FIG. 1 illustrates a schematic configuration example of an optical radio transmission system according to the present disclosure. An optical radio transmission system 10 includes a base unit 20 and a remote unit 30. The base unit 20 and the remote unit 30 are connected to each other via an optical transmission path. The remote unit 30 includes an antenna 31 and a vector decomposer 32. The vector decomposer 32 includes a phase rotation signal generator 33 and a combiner 34.

In the remote unit 30, a reception signal received by the antenna 31 is input to the vector decomposer 32. The phase rotation signal generator 33 generates a first phase rotation signal and a second phase rotation signal each having a phase rotated through 90° in a positive direction and a negative direction with respect to an input signal being the reception signal. The combiner 34 combines the input signal and the first phase rotation signal, and generates a first outphasing signal S₁. Further, the combiner 34 combines the input signal and the second phase rotation signal, and generates a second outphasing signal S₂.

The base unit 20 includes a combiner 21, an ADC 22, and a signal processing circuit 23. The base unit 20 receives the first outphasing signal S₁ and the second outphasing signal S₂ from the remote unit 30 via the optical transmission path. The combiner 21 combines the first outphasing signal S₁ and the second outphasing signal S₂, and regenerates a signal corresponding to the reception signal. The ADC 22 converts the regenerated reception signal from an analog signal into a digital signal. The signal processing circuit 23 performs signal processing on the reception signal that has been converted into the digital signal.

In the present disclosure, the vector decomposer 32 generates the first and second phase rotation signals having a phase difference of 90° in the positive direction and the negative direction with respect to the input signal. Furthermore, the vector decomposer 32 combines the input signal and the first phase rotation signal and combines the input signal and the second phase rotation signal, and generates one set of outphasing signals. A signal acquired by combining the one set of the outphasing signals generated by the vector decomposer 32 includes phase information and amplitude information being associated with phase information and amplitude information about the input signal. By using such a vector decomposer 32, the remote unit 30 can resolve a reception signal remaining as an analog signal into one set of outphasing signals. Thus, the remote unit 30 may not include the ADC, and can generate an outphasing signal with a simple configuration. Further, the optical radio transmission system 10 can transmit/receive a signal by an outphasing method from the remote unit 30 to the base unit 20 while using the remote unit 30 having a simple configuration.

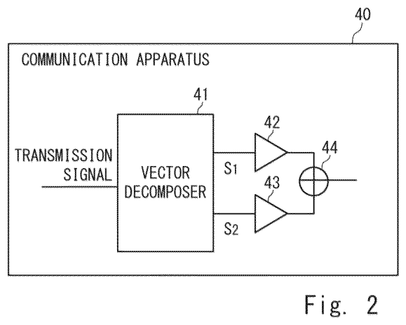

FIG. 2 is a block diagram illustrating a schematic configuration example of a communication apparatus according to the present disclosure. In this example, a communication apparatus 40 includes a vector decomposer 41, a first amplifier 42, a second amplifier 43, and a combiner 44. The configuration of the vector decomposer 41 is similar to the configuration of the vector decomposer 32 illustrated in FIG. 1. In this configuration, the vector decomposer 41 generates, from a transmission signal, the first outphasing signal S₁ and the second outphasing signal S₂.

The first amplifier 42 amplifies the first outphasing signal S₁. The second amplifier 43 amplifies the second outphasing signal S₂. The combiner 44 combines the amplified first outphasing signal S₁ and the amplified second outphasing signal S₂. A combined signal corresponds to an amplified transmission signal. The combined signal output from the combiner 44 is emitted by, for example, an antenna.

In the communication apparatus 40 illustrated in FIG. 2, a transmission signal can be amplified by the outphasing method by using the vector decomposer 41 having a simple configuration. Further, in the communication apparatus 40 illustrated in FIG. 2, the first outphasing signal S₁ and the second outphasing signal S₂ can be generated by using the vector decomposer 41 without converting an input analog signal into a digital signal. Therefore, in the communication apparatus 40, the configuration illustrated in FIG. 2 does not need the DAC between the first amplifier 42 and the second amplifier 43, and the vector decomposer 41. Further, the ADC is unnecessary on a prior stage of the vector decomposer 41. Thus, the configuration of the communication apparatus 40 can be simplified.

Hereinafter, example embodiments according to the present disclosure will be described in detail with reference to drawings. Note that, for clarification of the description, the description and the drawings below are appropriately omitted and simplified. Further, in each of the drawings, the same elements and similar elements will be denoted by the same reference signs, and repeated description will be omitted as necessary.

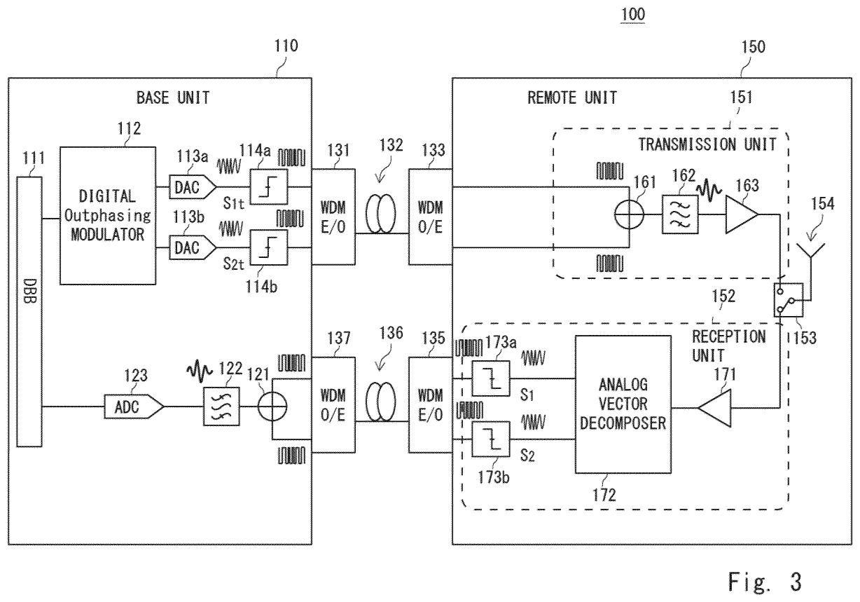

A first example embodiment will be described. FIG. 3 illustrates a configuration example of a first optical radio transmission system according to the present disclosure. An optical radio transmission system 100 illustrated in FIG. 3 includes a base unit 110 and a remote unit 150. The base unit 110 is, for example, a network apparatus disposed in a concentrator. The remote unit 150 is, for example, a network apparatus disposed in a fringe area. In the present example embodiment, the optical radio transmission system 100 is a system in which an optical signal is transmitted by a 1 bit outphasing method between the base unit 110 and the remote unit 150. Note that FIG. 3 illustrates only one remote unit 150, but the number of the remote units 150 is not limited to one. The optical radio transmission system 100 may include the plurality of remote units 150 for one base unit 110. The base unit 110 is associated with the base unit 20 illustrated in FIG. 1. The remote unit 150 is associated with the remote unit 30 illustrated in FIG. 1.

The base unit 110 includes a digital baseband unit (DBB) 111, a digital outphasing modulator 112, DACs 113a and 113b, rectangularizing units 114a and 114b, a combiner 121, a band-pass filter 122, and an ADC 123. The digital baseband unit 111 performs baseband signal processing in the base unit 110. The digital baseband unit 111 generates a digital baseband signal in signal transmission. The digital baseband unit 111 outputs an I component (in-phase component)/Q component (quadrature component) of a digital baseband signal to the digital outphasing modulator 112. The digital baseband unit 111 may be implemented by using hardware such as a digital signal processor (DSP), for example.

The digital outphasing modulator 112 generates one set of outphasing signals S₁ₜ and S₂ₜ from an input digital baseband signal. The digital outphasing modulator 112 includes a digital signal processing circuit and an orthogonal modulator. The digital outphasing modulator 112 converts the I component/Q component of the digital baseband signal into a pair of outphasing signals having a predetermined frequency. The digital outphasing modulator 112 may be implemented by using hardware such as a DSP, for example.

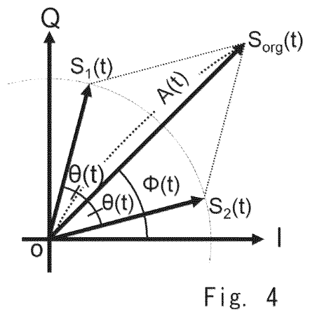

FIG. 4 illustrates a vector diagram of S₁ₜ(t), S₂ₜ(t), and S_{org}(t). The digital outphasing modulator 112 converts the original signal vector S_{org} subjected to amplitude modulation and phase modulation into a pair of outphasing signal vectors S₁ₜ and S₂ₜ having a fixed amplitude and only phase modulation. Note that, in the following description, a maximum value of an amplitude of the signal vector S_{org} is assumed to be Aₘₐₓ=2.

The outphasing signals S₁ₜ(t) and S₂ₜ(t) at each time t are expressed in the following equations by using I(t) and Q(t) being a radio orthogonal baseband signal.

$${S}_{1 t} ( t ) = \frac{{A}_{max}}{2} cos ( 2 π {f}_{c} t + ϕ ( t ) + θ ( t ) ) \qquad ( 1 )$$

$${S}_{2 t} ( t ) = \frac{{A}_{max}}{2} cos ( 2 π {f}_{c} t + ϕ ( t ) - θ ( t ) ) \qquad ( 2 )$$

$$θ ( t ) = {cos}^{- 1} ( \frac{A ( t )}{{A}_{max}} ) \qquad ( 3 )$$

$$\{ \begin{matrix}A ( t ) = \sqrt{{I}^{2} ( t ) + {Q}^{2} ( t )} \\ ϕ ( t ) = {tan}^{- 1} ( Q ( t ) / I ( t ) )\end{matrix} \qquad ( 4 )$$

In the equations described above, fc represents a carrier wave frequency, and Aₘₐₓ represents a maximum value of an amplitude A (t). When Aₘₐₓ=2, an amplitude of the outphasing signals S₁ₜ(t) and S₂ₜ(t) is 1. The original signal S_{org}(t) having the carrier wave frequency f_{c} can be regenerated by combining S₁ₜ(t) and S₂ₜ(t). In other words, the following equation 5 holds true.

$${S}_{org} ( t ) = {S}_{1 t} ( t ) + {S}_{2} t ( t ) = A ( t ) \{ cos ( 2 π {f}_{c} t + ϕ ( t ) ) \} \qquad ( 5 )$$

The DACs 113a and 113b respectively convert the outphasing signals S₁ₜ and S₂ₜ from a digital signal into an analog signal. The rectangularizing units 114a and 114b respectively convert, into a rectangular wave signal of a pulse waveform, the outphasing signals S₁ₜ and S₂ₜ that have been converted into the analog signal. The rectangularizing units 114a and 114b respectively compare the outphasing signals S₁ₜ and S₂ₜ with an amplitude zero value, and rectangularize the outphasing signals S₁ₜ and S₂ₜ, based on a comparison result.

As indicated by the equations (1) and (2) described above, the outphasing signal is a sinusoidal signal having a fixed amplitude. The rectangularizing units 114a and 114b can convert the outphasing signal into a pulse waveform without impairing information by rectangularizing the outphasing signal by zero value comparison. The pulse waveform corresponds to a waveform acquired by adding a harmonic component of the outphasing signal itself to the outphasing signal. This means that the outphasing signal can be regenerated from a rectangularized signal by using a filter that removes harmonics.

A wavelength division multiplexing (WDM) E/O converter 131 (hereinafter, also simply referred to as an E/O converter) converts the rectangularized outphasing signals S₁ₜ and S₂ₜ from electrical signals into optical signals. At this time, the E/O converter 131 converts the outphasing signals S₁ₜ and S₂ₜ into optical signals having wavelengths different from each other. An optical fiber 132 is an optical transmission path, and transmits the outphasing signals S₁ₜ and S₂ₜ that have been converted into the optical signals to the remote unit 150. A wavelength division multiplexing O/E converter 133 (hereinafter, also simply referred to as an O/E converter) converts the transmitted outphasing signals S₁ₜ and S₂ₜ from the optical signals into electrical signals.

The remote unit 150 includes a transmission unit 151, a reception unit 152, a transmission/reception switching circuit 153, and an antenna 154. In the remote unit 150, the outphasing signals S₁ₜ and S₂ₜ that have been converted into the electrical signals by the O/E converter 133 are input to the transmission unit 151. The transmission unit 151 includes a combiner 161, a band-pass filter 162, and an amplifier 163. The combiner 161 combines the outphasing signals S₁ₜ and S₂ₜ, and regenerates a radio frequency signal corresponding to the signal S_{org}. The combiner 161 outputs the regenerated radio frequency signal to the band-pass filter 162.

The band-pass filter 162 outputs a signal having a predetermined frequency component of the regenerated radio frequency signal to the amplifier 163. For example, the band-pass filter 162 removes a harmonic component caused by rectangularizing from frequency components included in the regenerated radio frequency signal. The amplifier 163 amplifies the input radio frequency signal to desired power. The amplifier 163 supplies the radio frequency signal to the antenna 154 via the transmission/reception switching circuit 153. The antenna 154 emits the radio frequency signal to, for example, a fringe area.

Note that the digital outphasing modulator 112 may generate an outphasing signal with an intermediate frequency signal. In that case, in the transmission unit 151, an intermediate frequency signal regenerated by the combiner 161 may be upconverted to a radio frequency signal.

The antenna 154 receives a radio frequency signal transmitted from a radio communication apparatus such as a user apparatus present in a fringe area. The radio frequency signal received by the antenna 154 is also called a reception signal. The radio frequency signal having a high frequency and being received by the antenna 154 is input to the reception unit 152 via the transmission/reception circuit 153. The antenna 154 is associated with the antenna 31 illustrated in FIG. 1.

The reception unit 152 includes an amplifier 171, an analog vector decomposer 172, and rectangularizing units 173a and 173b. The amplifier 171 amplifies a weak radio frequency signal. The amplifier 171 outputs the amplified radio frequency signal to the analog vector decomposer 172. The analog vector decomposer 172 generates one set of outphasing signals from the input radio frequency signal. In the present example embodiment, the analog vector decomposer 172 performs outphasing modulation on a radio frequency signal input as an analog signal without converting the radio frequency signal into a digital signal, and generates one set of outphasing signals S₁ and S₂.

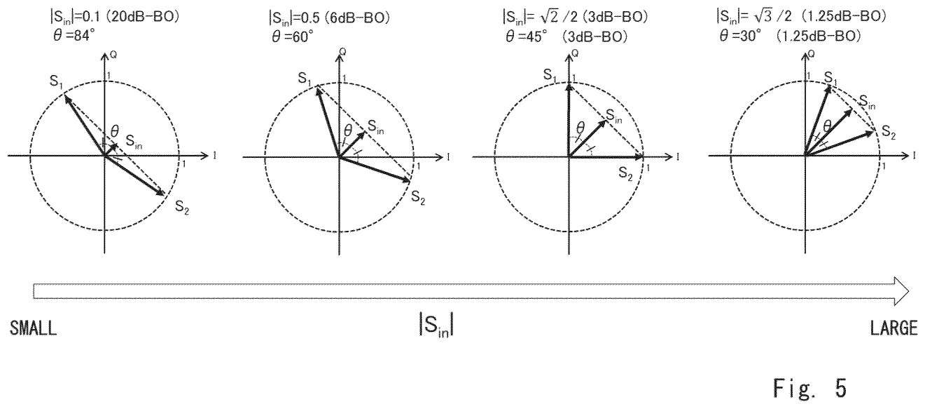

FIG. 5 illustrates an input signal Sᵢₙ of the analog vector decomposer 172 and the generated outphasing signals S₁ and S₂. The outphasing signals S₁ and S₂ are each a signal having a fixed amplitude regardless of a size of the input Sᵢₙ. A vector sum of the outphasing signals S₁ and S₂ corresponds to twice an amplitude of the input signal Sᵢₙ with regard to an amplitude. A phase of a vector sum of the outphasing signals S₁ and S₂ is the same as a phase of the input signal Sᵢₙ. Note that the input signal Sᵢₙ corresponds to a value acquired by multiplying the above-described signal S_{org} by 0.5, and thus the following relational expression holds true from the equation (5).

$${S}_{in} ( t ) = 0.5 \cdot {S}_{org} ( t ) = 0.5 \cdot ( {S}_{1} ( t ) + {S}_{2} ( t ) ) = 0.5 \cdot A ( t ) \{ 2 π {f}_{c} t + ϕ ( t ) ) \} \qquad ( 6 )$$

Vector angles of the outphasing signals S₁ and S₂ with respect to the input signal Sᵢₙ are respectively θ and −θ indicated by the equation (3). The vector angles are smaller as an amplitude of Sᵢₙ is greater, i.e., as A(t) is greater. FIG. 5 illustrates a representative set of specific values of Sᵢₙ and θ.

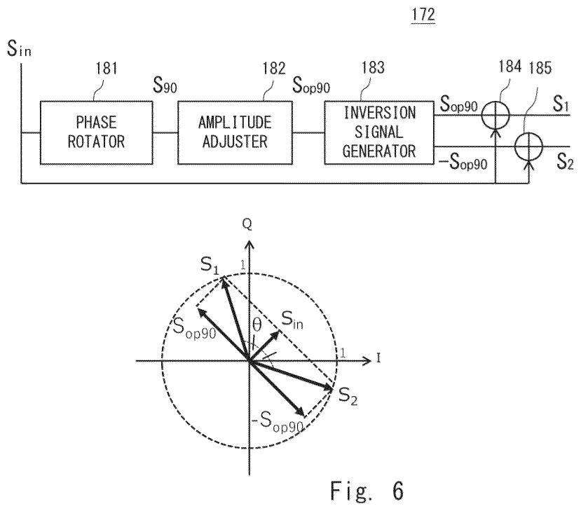

FIG. 6 illustrates a configuration example of the analog vector decomposer 172. The analog vector decomposer 172 includes a phase rotator 181, an amplitude adjuster 182, an inversion signal generator 183, and combiners 184 and 185. Note that an operation of the analog vector decomposer 172 is associated with an analog vector decomposition method. The analog vector decomposer 172 is associated with the vector decomposer 32 illustrated in FIG. 1.

The phase rotator 181 generates a signal S₉₀ having a phase going forward by 90° with respect to the input signal Sᵢₙ. The amplitude adjuster 182 adjusts an amplitude of the signal S₉₀ to a desired value, and generates a signal Sₒₚ₉₀. The inversion signal generator 183 generates a sign inverted signal −Sₒₚ₉₀, i.e., a signal whose sign is inverted from the sign of the signal Sₒₚ₉₀. The inversion signal generator 183 may generate the sign inverted signal −Sₒₚ₉₀ by, for example, differential signaling. The inversion signal generator 183 may generate the sign inverted signal −Sₒₚ₉₀ by using an inverting circuit. The signal S₉₀ and the signal Sₒₚ₉₀ are also called a first phase rotation signal. The signal −S₉₀ and the signal-Sₒₚ₉₀ are also called a second phase rotation signal. The phase rotator 181 and the inversion signal generator 183 are associated with the phase rotation signal generator 33 illustrated in FIG. 1.

The combiner 184 combines vectors of the input signal Sᵢₙ and the signal Sₒₚ₉₀. The combiner 184 outputs, as the outphasing signal S₁, the signal acquired by combining the vectors of the input signal Sᵢₙ and the signal Sₒₚ₉₀. The combiner 185 combines vectors of the input signal Sᵢₙ and the signal −Sₒₚ₉₀. The combiner 185 outputs, as the outphasing signal S₂, the signal acquired by combining the vectors of the input signal Sᵢₙ and the signal −Sₒₚ₉₀. The outphasing signal S₁ is also called a first outphasing signal. The outphasing signal S₂ is also called a second outphasing signal. The combiners 184 and 185 are associated with the combiner 34 illustrated in FIG. 1.

Note that the example in which the analog vector decomposer 172 generates the signal S₉₀ having the phase going forward by 90° with respect to the input signal Sᵢₙ in the phase rotator 181, and adjusts an amplitude of the signal S₉₀ in the amplitude adjuster 182 is described above. However, the present example embodiment is not limited to this. An order of the phase rotator 181 and the amplitude adjuster 182 may be reversed. In other words, the analog vector decomposer 172 may adjust an amplitude of the input signal Sᵢₙ in the amplitude adjuster 182, and then generate, in the phase rotator 181, a signal having a phase going forward by 90° with respect to the input signal Sᵢₙ from the input signal having the amplitude adjusted.

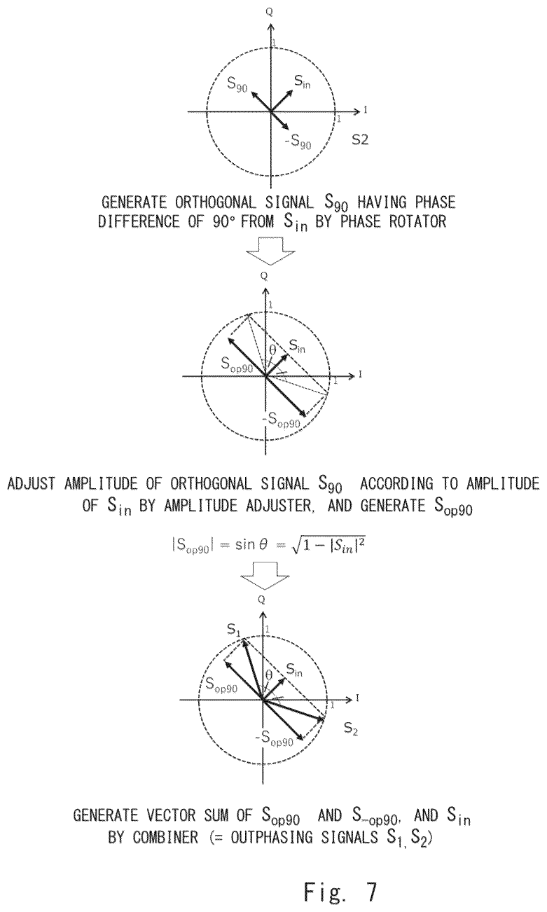

FIG. 7 illustrates a generation process of an outphasing signal in the analog vector decomposer 172. The phase rotator 181 generates, from the input signal Sᵢₙ, a signal having a phase difference of 90° from the input signal Sᵢₙ, i.e., the signal S₉₀ being an orthogonal signal. The signal S₉₀ is also called a first phase rotation signal. The amplitude adjuster 182 adjusts the signal S₉₀ based on an amplitude of the input signal Sᵢₙ. For example, the amplitude adjuster 182 adjusts an amplitude of the signal S₉₀ in such a way that an amplitude of an outphasing signal generated by combining vectors of the input signal and the signal Sₒₚ₉₀ after an amplitude adjustment is a predetermined amplitude, for example, “1”. Specifically, the amplitude adjuster 182 adjusts an amplitude of the signal S₉₀ in such a way that an amplitude value of the output signal Sₒₚ₉₀ is a value represented in the following equation.

$$\vert {S}_{op 90} \vert = \sqrt{1 - {\vert {S}_{i n} \vert}^{2}} \qquad ( 7 )$$

The combiner 184 combines vectors of the input signal Sᵢₙ and the signal Sₒₚ₉₀. The combiner 185 combines vectors of the input signal Sᵢₙ and the signal-Sₒₚ₉₀. Since the input signal Sᵢₙ and the signal Sₒₚ₉₀ are orthogonal to each other, an absolute value of a vector signal after vector combination is equivalent to a sum of squares of the input signal Sᵢₙ and the signal Sₒₚ₉₀, and is 1. Similarly, since the input signal Sᵢₙ and the signal −Sₒₚ₉₀ are orthogonal to each other, an absolute value of a vector signal after vector combination is equivalent to a sum of squares of the input signal Sᵢₙ and the signal −Sₒₚ₉₀, and is 1. When a phase difference between a signal acquired by combining the vectors of the input signal Sᵢₙ and the signal Sₒₚ₉₀, and the input signal Sᵢₙ is θ, a phase difference between the signal acquired by combining the vectors of the input signal Sᵢₙ and the signal −Sₒₚ₉₀, and the input signal Sᵢₙ is −θ. As clear from FIG. 7, the following equation also holds true.

$$\vert {S}_{op 90} \vert = sin ( θ ) \qquad ( 8 )$$

A signal acquired by combining vectors of an output signal of the combiner 184 and an output signal of the combiner 185 is a signal acquired by combining vectors of Sᵢₙ×2, Sₒₚ₉₀, and −Sₒₚ₉₀, and is equivalent to Sᵢₙ×2. This indicates that signals output from the combiners 184 and 185 are respectively signals equivalent to the outphasing signals S₁ₜ and S₂ₜ indicated in the equations (1) and (2). Further, the phase difference θ between the signal acquired by combining the vectors of the input signal Sᵢₙ and the signal Sₒₚ₉₀, and the input signal Sᵢₙ is also the same as θ indicated in the equations (1) and (2).

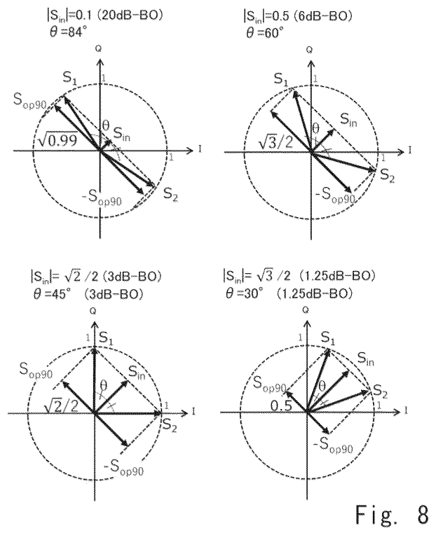

FIG. 8 illustrates a relationship between the input signal Sᵢₙ and the outphasing signals S₁ and S₂. FIG. 8 illustrates, as a representative example, a specific amplitude value of Sₒₚ₉₀ together with a vector diagram for each of cases where a backoff value of an amplitude of the input signal Sᵢₙ is 20 dB, 6 dB, 3 dB, and 1.25 dB.

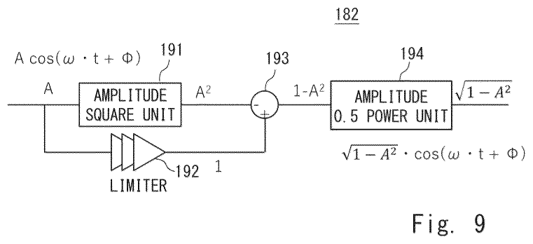

FIG. 9 illustrates a configuration example of the amplitude adjuster 182. The amplitude adjuster 182 includes an amplitude square unit 191, a limiter 192, a differential unit 193, and an amplitude 0.5 power unit 194. Herein, the signal S₉₀ being an input signal to the amplitude adjuster is assumed to be represented as Acos (ωt+φ) in which ω=2πfc. The amplitude square unit 191 squares an amplitude of the input signal and outputs the signal. In other words, the amplitude square unit 191 amplifies an amplitude of the signal S₉₀ being the input signal to the square of A. The limiter 192 saturates the input signal, and outputs a signal having an amplitude of “1”.

The differential unit 193 outputs a difference between the output signal of the amplitude square unit 191 and the output signal of the limiter 192. The differential unit 193 includes a differential circuit. The differential circuit outputs a differential signal between the output signal of the amplitude square unit 191 being input to one of differential input terminals and the output signal of the limiter 192 being input to the other differential input terminal. An amplitude of the differential signal output from the differential unit 193 is 1−A². Herein, it is assumed that A≤1. The differential unit 193 outputs the differential signal to the amplitude 0.5 power unit 194.

The amplitude 0.5 power unit 194 raises an amplitude of the signal being input from the differential unit 193 to 0.5 power, and outputs the signal. The amplitude 0.5 power unit 194 outputs the signal having the amplitude raised to 0.5 power as the signal Sₒₚ₉₀ having the amplitude adjusted. An amplitude of the signal output from the amplitude 0.5 power unit 194 is represented as (1−A₂)^{1/2}. Since the amplitudes of the input signal Sᵢₙ and the signal S₉₀ of the analog vector decomposer 172 are equivalent, the signal Sₒₚ₉₀ having the amplitude adjusted satisfies a relationship indicated in an equation (7) with respect to the input signal Sᵢₙ.

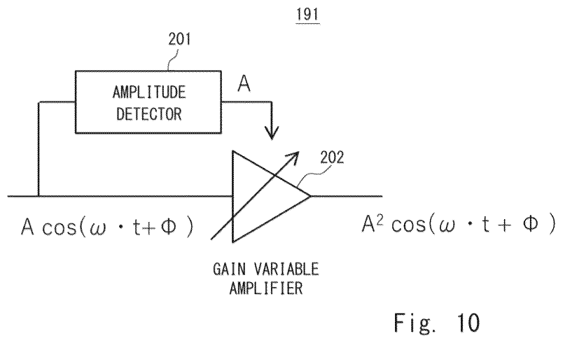

FIG. 10 illustrates a configuration example of the amplitude square unit 191. The amplitude square unit 191 includes an amplitude detector 201 and a gain variable amplifier 202. The amplitude detector 201 detects an amplitude A of an input signal. The amplitude detector 201 can be achieved by using, for example, a diode detection circuit and the like. The amplitude detector 201 outputs the detected amplitude A as a gain control signal to the gain variable amplifier 202. The gain variable amplifier 202 amplifies the input signal at an amplification factor in accordance with the gain control signal. The gain variable amplifier 202 amplifies a signal in such a way that an amplitude of an output signal has a value proportional to the square of the detected amplitude A. A constant of proportionality can be adjusted as a circuit constant, and a constant of proportionality is set to 1 in the present example embodiment.

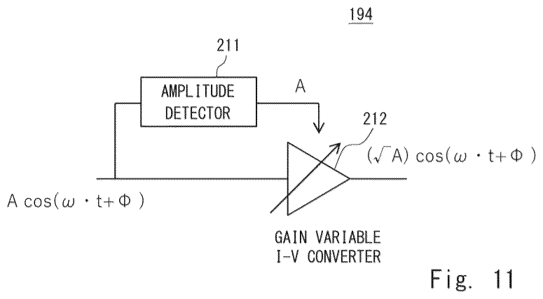

FIG. 11 illustrates a configuration example of the amplitude 0.5 power unit 194. The amplitude 0.5 power unit 194 includes an amplitude detector 211 and a gain variable I-V converter 212. The amplitude detector 211 detects an amplitude A of an input signal. The amplitude detector 211 can be achieved by using, for example, a diode detection circuit and the like. The amplitude detector 211 outputs a control signal corresponding to magnitude of the detected amplitude A to the gain variable I-V converter 212. The gain variable I-V converter 212 changes an amplitude of an output signal in accordance with the control signal being input from the amplitude detector 211.

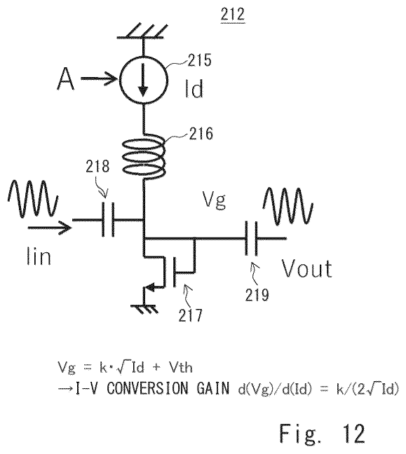

FIG. 12 illustrates a configuration example of the gain variable I-V converter 212. The gain variable I-V converter 212 includes a current source 215, an inductor 216, a field effect transistor (FET) 217, and capacitors 218 and 219. A transistor such as, for example, a metal oxide semiconductor (MOS) FET is used for the FET 217. The FET 217 is diode-connected, and connected to the current source 215 via the inductor 216. A gate terminal and a drain terminal of the FET 217 are short-circuited, and an output signal of the differential unit 193 (see FIG. 9) is input to the drain terminal of the FET 217 via the capacitor 218. The gain variable I-V converter 212 outputs a signal having an amplitude raised to 0.5 power from the drain terminal of the FET 217 via the capacitor 219.

In the gain variable I-V converter 212, a current (Iin) of the output signal of the differential unit 193 is input to the drain terminal of the diode-connected FET, and a voltage Vout appearing at the same terminal is output as an output signal. With regard to the FET 217, the following relational expression holds true between a drain current Id and a gate voltage Vg.

$$Vg = k \sqrt{Id} + Vth \qquad ( 9 )$$

Herein, k is a constant, and Vth is a threshold value voltage of the FET 217. An I-V conversion gain Gcon is acquired by differentiating Vg by Id.

$$Gcon = k / ( 2 \sqrt{Id} ) \qquad ( 10 )$$

The expression described above means that the conversion gain of the gain variable I-V converter 212 is proportional to −0.5 power of Id.

In the amplitude 0.5 power unit 194 illustrated in FIG. 12, a direct-current component of the current Id output from the current source 215 is controlled in accordance with the amplitude A detected by the amplitude detector 211 (see FIG. 11). In this way, the I-V conversion gain can be set proportional to −0.5 power of the amplitude A. An amplitude value of an output of the amplitude 0.5 power unit 194 is proportional to a product of the amplitude A of the input signal and the I-V conversion gain. In other words, an amplitude value of an output of the amplitude 0.5 power unit 194 is proportional to 0.5 power of the amplitude A. A constant of proportionality can be adjusted as a circuit constant. In the present example embodiment, a constant of proportionality is set to 1.

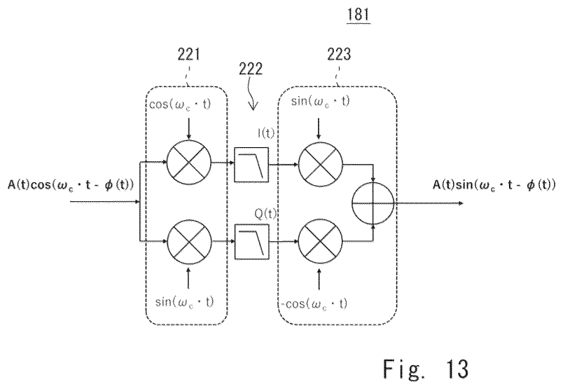

FIG. 13 illustrates a configuration example of the phase rotator 181. The phase rotator 181 includes an orthogonal demodulator 221, a low-pass filter 222, and an orthogonal modulator 223. The orthogonal demodulator 221 includes mixer circuits associated with an I component and a Q component, and orthogonally demodulates the input signal Sᵢₙ. The low-pass filter 222 passes a low-frequency component of each of a signal I(t) of the I component and a signal Q(t) of the Q component being demodulated. The orthogonal modulator 223 includes mixer circuits associated with the I component and the Q component and a combiner that combines outputs of the mixer circuits, and orthogonally modulates the signal I(t) of the I component and the signal Q(t) of the Q component. A phase difference between a local signal used in the orthogonal demodulator 221 and a local signal used in the orthogonal modulator 223 is 90°. With the present configuration, the phase rotator 181 can output a signal having a phase difference of 90° from an input signal.

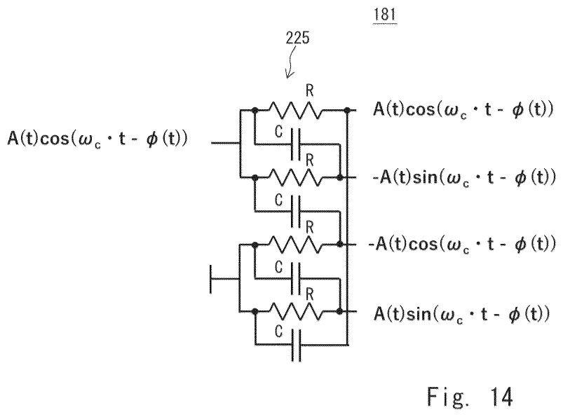

FIG. 14 illustrates another configuration example of the phase rotator 181. In this example, the phase rotator 181 is formed as an RC polyphase filter 225 including resistors R and capacitors C. The RC polyphase filter 225 can output each signal having a phase difference of 0°, 90°, 180°, and 270° from an input signal. The phase rotator 181 outputs the signal having the phase difference of 90° from the input signal among the four signals. Note that, in the configuration of the analog vector decomposer 172 illustrated in FIG. 6, the input signal Sᵢₙ is branched and input to the combiners 184 and 185. When the RC polyphase filter 225 is used for the phase rotator 181, a signal having a phase difference of 0° among output signals of the RC polyphase filter 225 may be input to the combiners 184 and 185.

Returning to FIG. 3, the rectangularizing units 173a and 173b respectively rectangularize the outphasing signals S₁ and S₂ output from the analog vector decomposer 172. A rectangularizing method in the rectangularizing units 173a and 173b may be similar to a rectangularizing method in the rectangularizing units 114a and 114b of the base unit 110.

A wavelength division multiplexing E/O converter 135 converts, from electrical signals into optical signals, the rectangularized outphasing signals S₁ and S₂ being output from the rectangularizing units 173a and 173b. At this time, the E/O converter 135 converts the outphasing signals S₁ and S₂ into optical signals having wavelengths different from each other. An optical fiber 136 transmits the outphasing signals S₁ and S₂ that have been converted into the optical signals to the base unit 110. A wavelength division multiplexing O/E converter 137 converts the outphasing signals S₁ and S₂ from the optical signals into electrical signals.

In the base unit 110, the combiner 121 combines the outphasing signals S₁ and S₂, and regenerates a signal corresponding to a reception signal being input to the analog vector decomposer 172. The combiner 121 is associated with the combiner 21 illustrated in FIG. 1.

The band-pass filter 122 outputs a signal having a predetermined frequency component of the input regenerated reception signal, i.e., a radio frequency signal to the ADC 123. For example, the band-pass filter 162 removes a harmonic component caused by rectangularizing from frequency components included in the regenerated radio frequency signal. The ADC 123 converts the radio frequency signal from an analog signal into a digital signal. The ADC 123 outputs the radio frequency signal that has been converted into the digital signal to the digital baseband unit 111. The ADC 123 is associated with the ADC 22 illustrated in FIG. 1. The digital baseband unit 111 is associated with the signal processing circuit 23 illustrated in FIG. 1.

In the present example embodiment, the analog vector decomposer 172 generates one set of the outphasing signals S₁ and S₂ from a reception signal being an analog signal. The analog vector decomposer 172 can generate the one set of the outphasing signals S₁ and S₂ without converting the reception signal being the analog signal into a digital signal. The analog vector decomposer 172 can convert the reception signal remaining as the analog signal into the one set of the outphasing signals S₁ and S₂, and thus the reception signal does not need to be converted into the digital signal, which is accompanied by conversion into an outphasing signal. Thus, the analog vector decomposer 172 can convert the reception signal into the one set of the outphasing signals S₁ and S₂ with a simple configuration.

In the present example embodiment, the remote unit 150 generates an outphasing signal by using the analog vector decomposer 172 in the reception unit 152. Thus, the remote unit 150 does not need to include an ADC that converts a reception signal into a digital signal and a DAC that converts a generated outphasing signal into an analog signal. Therefore, in the present example embodiment, as compared to a case where a reception signal is converted into a digital signal, an outphasing signal is generated by the digital signal processing, and the generated outphasing signal is converted into an analog signal, the configuration of the remote unit 150 can be simplified. In the present example embodiment, the remote unit 150 does not require the ADC and the DAC having great power consumption. Thus, in the present example embodiment, a size reduction and power savings of the reception unit 152 can be achieved.

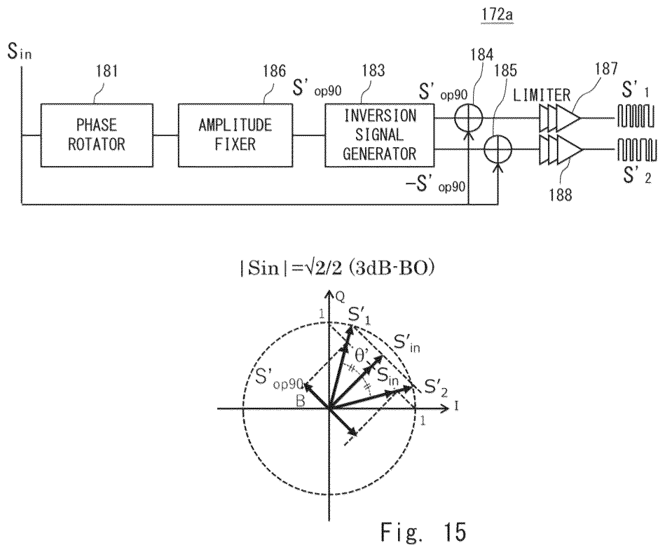

Next, a second example embodiment will be described. FIG. 15 is another configuration example of an analog vector decomposer according to the present disclosure. An analog vector decomposer 172a illustrated in FIG. 15 may be used instead of the analog vector decomposer 172 in the reception unit 152 of the remote unit 150 illustrated in FIG. 3. The analog vector decomposer 172a illustrated in FIG. 15 includes a phase rotator 181, an inversion signal generator 183, combiners 184 and 185, an amplitude fixer 186, and limiters 187 and 188.

The phase rotator 181 generates a signal S₉₀ having a phase going forward by 90° with respect to an input signal Sᵢₙ. The amplitude fixer 186 sets an amplitude of the signal S₉₀ to a predetermined amplitude, and generates S′ₒₚ₉₀ having the amplitude fixed to the predetermined amplitude. The amplitude fixer 186 includes, for example, the limiter 192 illustrated in FIG. 9, and the gain variable amplifier 202 illustrated in FIG. 10. In the amplitude fixer 186, the limiter and the gain variable amplifier are cascade-connected. The limiter sets an amplitude of the input signal Sᵢₙ to 1 by amplifying the input signal Sᵢₙ to a saturation state. An amplification factor of the gain variable amplifier is set to B, and an amplitude of the input signal Sᵢₙ having the amplitude of 1 is set to B. With such a configuration, the amplitude fixer 186 can fix the amplitude of the output S′ₒₚ₉₀ to B without depending on magnitude of the amplitude of the input signal Sᵢₙ.

The inversion signal generator 183 generates a sign inverted signal −S′ₒₚ₉₀, i.e., a signal whose sign is inverted from the signal S′ₒₚ₉₀ having the fixed amplitude. The inversion signal generator 183 may generate the sign inverted signal −S′ₒₚ₉₀ by, for example, differential signaling. Alternatively, the inversion signal generator 183 may generate the sign inverted signal −S′ₒₚ₉₀ by using an inverting circuit.

The combiner 184 combines vectors of the input signal Sᵢₙ and the signal S′ₒₚ₉₀. The limiter 187 amplifies a signal acquired by combining the vectors of the input signal Sᵢₙ and the signal S′ₒₚ₉₀ until an amplitude is saturated, and generates a pseudo-outphasing signal S′₁ having an amplitude of 1. The combiner 185 combines vectors of the input signal Sᵢₙ and the signal −S′ₒₚ₉₀. The limiter 188 amplifies a signal acquired by combining the vectors of the input signal Sᵢₙ and the signal −S′ₒₚ₉₀ until an amplitude is saturated, and generates a pseudo-outphasing signal S′₂ having an amplitude of 1. Note that, in the present example embodiment, an order of the phase rotator 181 and the amplitude fixer 186 may be switched.

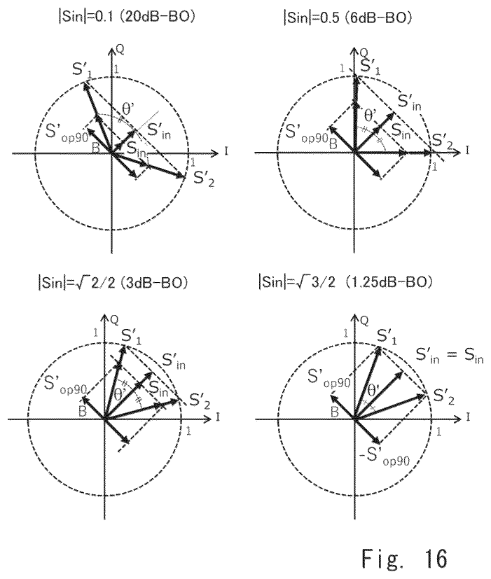

FIG. 16 illustrates an operation of the analog vector decomposer 172a in a vector diagram. The amplitude fixer 186 outputs the signal S′ₒₚ₉₀ having a phase difference of 90° from the input signal Sᵢₙ and having a fixed amplitude. The amplitude of the signal S′ₒₚ₉₀ is fixed without depending on the amplitude of the input signal Sᵢₙ. In the example in FIG. 16, |S′ₒₚ₉₀|=0.5. The combiner 184 combines the vectors of the input signal Sᵢₙ and the signal S′ₒₚ₉₀. The limiter 187 sets an amplitude of an output signal of the combiner 184 to “1”, and generates the pseudo-outphasing signal S′₁. The combiner 185 combines the vectors of the input signal Sᵢₙ and the signal −S′ₒₚ₉₀. The limiter 188 sets an amplitude of an output signal of the combiner 185 to “1”, and generates the pseudo-outphasing signal S′₂. FIG. 16 illustrates the pseudo-outphasing signals S′₁ and S′₂ with respect to several representative input signals Sᵢₙ having amplitudes different from one another.

Herein, in the present example embodiment, a combined signal S′ᵢₙ acquired by combining the pseudo-outphasing signals S′₁ and S′₂ does not coincide with the input signal Sᵢₙ except for specific cases. When a phase angle between the combined signal S′ᵢₙ and the pseudo-outphasing signal S′₁ is θ′, the following equation holds true in consideration that the amplitude of the pseudo-outphasing signal S′₁ is 1.

$$tan ( {θ}^{′} ) = \sqrt{1 - {\vert {S}_{in}^{′} \vert}^{2}} / \vert {S}_{in}^{′} \vert \qquad ( 11 )$$

Further, θ′ is also equivalent to a phase angle between a combined signal of the input signal Sᵢₙ and S′ₒₚ₉₀, and the input signal Sᵢₙ. Therefore, the following equation holds true.

$$tan ( {θ}^{′} ) = \vert {S}_{op 90}^{′} \vert / \vert {S}_{i n} \vert \qquad ( 12 )$$

The following equation holds true from the equations (11) and (12) described above.

$$\vert {S}_{in}^{′} \vert = \frac{\vert {S}_{in} \vert}{\sqrt{{\vert {S}_{in} \vert}^{2} + {\vert {S}_{op 90}^{′} \vert}^{2}}} = f ( \vert {S}_{in} \vert ) \qquad ( 13 - 1 )$$

Further, the following equation (13-2) holds true from the equations (11) and (12) described above.

$$\vert {S}_{in} \vert = \vert {S}_{op 90}^{′} \vert \cdot \vert {S}_{in}^{′} \vert / \sqrt{1 - {\vert {S}_{in}^{′} \vert}^{2}} = g ( \vert {S}_{in}^{′} \vert ) \qquad ( 13 - 2 )$$

Herein, |S′ₒₚ₉₀| is an amplitude of an output signal of the amplitude fixer 186 and is set freely.

When the equation (13-1) described above is regarded as a function f of |Sᵢₙ| and the equation (13-2) is regarded as a function g of |S′ᵢₙ|, g is an inverse function of f, and g·f(x)=x holds true. Note that the input signal Sᵢₙ and the combined signal S′ᵢₙ have an equivalent phase and only different amplitudes. In consideration of this point, the following relationship holds true from the equations (13-1) and (13-2).

$${S}_{in}^{′} = 1 / \sqrt{{\vert {S}_{in} \vert}^{2} + {\vert {S}_{op 90}^{′} \vert}^{2}} \cdot {S}_{in} \qquad ( 14 - 1 )$$

$${S}_{in} = \vert {S}_{op 90}^{′} \vert / \sqrt{1 - {\vert {S}_{in}^{′} \vert}^{2}} \cdot {S}_{in}^{′} \qquad ( 14 - 2 )$$

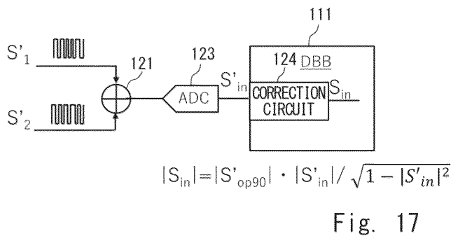

FIG. 17 illustrates a configuration example of a digital baseband unit 111 included in a base unit 110. Note that FIG. 17 does not illustrate the band-pass filter 122 illustrated in FIG. 3. In this example, the digital baseband unit 111 includes a correction circuit (first correction circuit) 124. In the base unit 110, a combiner 121 combines the pseudo-outphasing signals S′₁ and S′₂, and generates the combined signal S′ᵢₙ.

An ADC 123 converts the combined signal S′ᵢₙ from an analog signal into a digital signal. The combined signal S′ᵢₙ that has been converted into the digital signal is input to the correction circuit 124. The correction circuit 124 corrects the combined signal S′ᵢₙ, based on the combined signal S′ᵢₙ and the fixed amplitude |S′ₒₚ₉₀| set in the amplitude fixer 186, and regenerates the input signal Sᵢₙ. The correction circuit 124 performs a computation of the equation (14-2) described above, for example, and generates the input signal Sᵢₙ from the combined signal S′ᵢₙ.

Note that the fixed amplitude |S′ₒₚ₉₀| is equivalent to a set value B of an output amplitude of the amplitude fixer 186 included in the analog vector decomposer 172a. The input signal Sᵢₙ of the analog vector decomposer 172a is subjected to conversion of the equation (14-1) in the analog vector decomposer 172a and then subjected to conversion of the equation (14-2) in the correction circuit 124. The input signal Sᵢₙ is subjected to conversion of the equations (13-1) and (13-2) for amplitude, but both of the equations have a relationship of an inverse function, and thus an output amplitude of the correction circuit 124 is equivalent to an amplitude of the input signal Sᵢₙ. When it is considered that phase information is not subjected to conversion action in each block and is thus saved, an output of the correction circuit 124 means regeneration of the input signal Sᵢₙ.

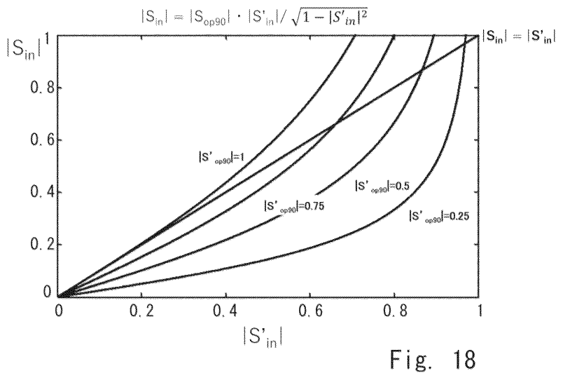

FIG. 18 illustrates an input/output characteristic of the correction circuit 124. In FIG. 18, a horizontal axis indicates magnitude, i.e., an amplitude of the combined signal S′ᵢₙ. A vertical axis indicates an amplitude of the input signal Sᵢₙ. FIG. 18 illustrates a curved line S′ᵢₙ−Sᵢₙ for four values of 0.25, 0.5, 0.75, and 1 as values of |S′ₒₚ₉₀|.

Note that the correction circuit 124 may not necessarily need to accurately perform a computation of the equation (14-2). The correction circuit 124 may perform a computation by using an equation approximating the curved line illustrated in FIG. 18 based on the value of |S′ₒₚ₉₀|, and regenerate the input signal Sᵢₙ. In that case, the computation can be simplified while accuracy of the regenerated input signal is maintained. When signal accuracy required of a regenerated input signal is low, the correction circuit 124 may not perform a computation for correction. In other words, when signal accuracy required of a regenerated input signal is low, the digital baseband unit 111 may not include the correction circuit.

In the present example embodiment, in the analog vector decomposer 172a, the amplitude fixer 186 sets an amplitude of the signal S′ₒₚ₉₀ to a fixed amplitude without depending on an amplitude of an input signal. In the present example embodiment, the analog vector decomposer 172a does not need to adjust an amplitude of the signal S′ₒₚ₉₀ in accordance with an amplitude of an input signal, and implementation of the analog vector decomposer 172a is easier than the first example embodiment in which an amplitude adjustment is performed. The digital baseband unit 111 of the base unit 110 includes the correction circuit 124. An amplitude of a signal acquired by combining vectors of pseudo-outphasing signals generated in the analog vector decomposer 172a does not coincide with an amplitude of an input signal. In the correction circuit 124, an amplitude of an input signal can be reproduced by correcting a signal acquired by combining vectors by using an inverse function of an input/output function of the analog vector decomposer 172a.

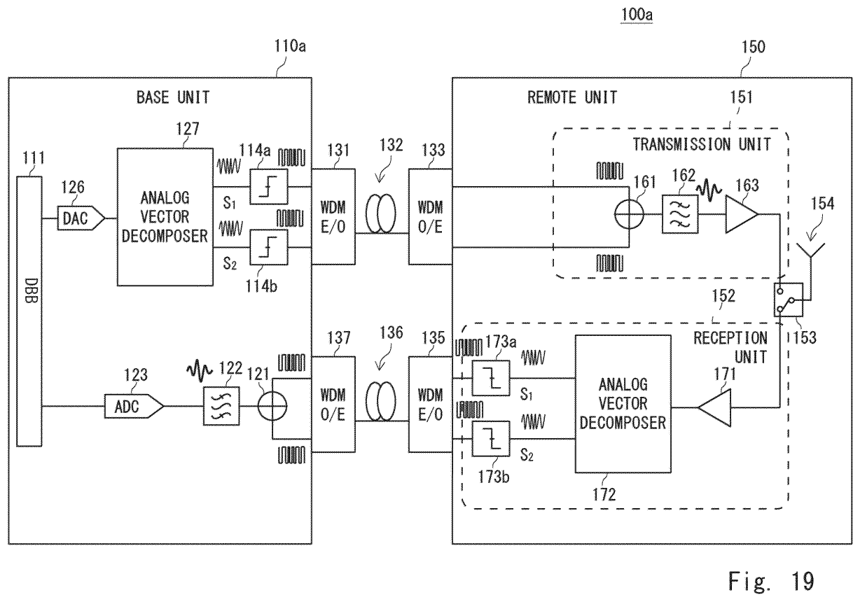

Next, a third example embodiment will be described. FIG. 19 illustrates a configuration example of a second optical radio transmission system according to the present disclosure. In an optical radio transmission system 100a illustrated in FIG. 19, a transmission unit of a base unit 110a includes an analog vector decomposer 127. An analog vector decomposer having a similar configuration to that of the analog vector decomposer 172 described in the first example embodiment is used for the analog vector decomposer 127. Alternatively, an analog vector decomposer having a similar configuration to that of the analog vector decomposer 172a described in the second example embodiment may be used for the analog vector decomposer 127.

In the present example embodiment, a digital baseband unit 111 has a function of orthogonally modulating a baseband signal. At a time of signal transmission, the digital baseband unit 111 outputs an orthogonally modulated baseband signal to a DAC 126. The DAC 126 converts the input orthogonally modulated signal from a digital signal into an analog signal. The analog vector decomposer 127 generates one set of outphasing signals S₁ and S₂ from the orthogonally modulated signal that has been converted into the analog signal by the DAC 126. A signal input to the analog vector decomposer 127 is also called a transmission signal. Generation of the outphasing signals S₁ and S₂ may be similar to generation of the outphasing signals S₁ and S₂ in an analog vector decomposer 172 disposed in a reception unit 152 of a remote unit 150.

Rectangularizing units 114a and 114b convert the outphasing signals S₁ and S₂ output from the analog vector decomposer 127 into a rectangular wave signal of a pulse waveform. The outphasing signals S₁ and S₂ are transmitted to the remote unit 150 via a wavelength division multiplexing E/O converter 131, an optical fiber 132, and a wavelength division multiplexing O/E converter 133. An operation of the transmission unit 151 in the remote unit 150 and an operation of the base unit 110 and the remote unit 150 at a time of radio frequency signal reception may be similar to the operation described in the first example embodiment or the operation described in the second example embodiment.

In the present example embodiment, the base unit 110 converts a transmission signal into the one set of the outphasing signals S₁ and S₂ by using the analog vector decomposer 127. As compared to the first example embodiment, in the configuration illustrated in FIG. 3, the base unit 110 includes the two DACs 113a and 113b in the transmission unit in order to each convert the one set of the outphasing signals S₁ and S₂ into an analog signal. In contrast, in the present example embodiment, the base unit 110 may include one DAC 126 that converts a transmission signal into an analog signal. Therefore, in the present example embodiment, the number of the DACs of the base unit 110 can be reduced from two to one.

Note that, when an analog vector decomposer similar to the analog vector decomposer 172a (see FIG. 15) is used in the base unit 110, as described above, a combined signal acquired by combining vectors of pseudo-outphasing signals does not generally coincide with the input signal Sᵢₙ. When an analog vector decomposer having a similar configuration to that of the analog vector decomposer 172a (see FIG. 15) is used, the digital baseband unit 111 may include a correction circuit (second correction circuit) that corrects a transmitted signal.

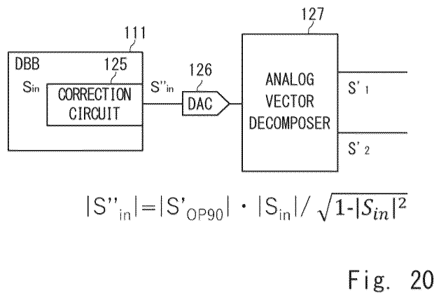

FIG. 20 illustrates a configuration example of a part of the transmission unit of the base unit 110. In this example, an analog vector decomposer having a similar configuration to that of the analog vector decomposer 172a is used for the analog vector decomposer 127. The analog vector decomposer 127 generates the pseudo-outphasing signals S′₁ and S′₂ described in the second example embodiment.

The digital baseband unit 111 includes a correction circuit 125. The correction circuit 125 corrects an amplitude of a transmission signal being input to the analog vector decomposer 172 in accordance with the amplitude of the transmission signal and a predetermined amplitude. The correction circuit 125 corrects a digital baseband signal in such a way that, for example, an amplitude of a signal acquired by combining vectors of the pseudo-outphasing signals S′₁ and S′₂ is the same as the amplitude of the transmission signal. Specifically, the correction circuit 125 corrects an input signal Sᵢₙ to a signal S′″ᵢₙ by using a function g indicated in the equation (13-2). The corrected signal S″ᵢₙ is input to the analog vector decomposer 127 via the DAC 126.

Note that an amplitude of the signal Sᵢₙ input to the correction circuit 125 is converted by the function g of the equation (13-2) in the correction circuit 125, and is then converted by the function f of the equation (13-1) in the analog vector decomposer 127. Thus, an amplitude of the signal acquired by combining the pseudo-outphasing signals S′₁ and S′₂ output from the analog vector decomposer 127 is f·g(|Sᵢₙ|). As described above, since f and g have a relationship of an inverse function, an original amplitude of Sᵢₙ is reproduced in the signal acquired by combining the pseudo-outphasing signals S′₁ and S′₂.

Note that, in each of the example embodiments described above, the example in which the analog vector decomposer is used for the optical radio transmission system is described. However, the present disclosure is not limited to this. The outphasing signals S₁ and S₂ do not necessarily need to be transmitted by using an optical fiber. The analog vector decomposer may be used in a circuit that converts a signal vector subjected to amplitude modulation and phase modulation into one set of outphasing signals having a fixed amplitude and only phase modulation in an analog region.

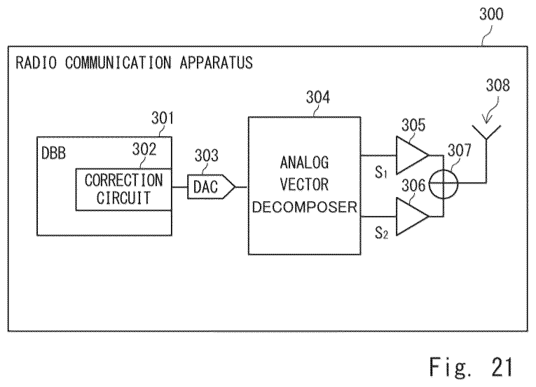

FIG. 21 illustrates an example in which the analog vector decomposer is applied to a radio communication apparatus. In this example, a radio communication apparatus 300 includes a digital baseband unit 301, a DAC 303, an analog vector decomposer 304, amplifiers 305 and 306, a combiner 307, and an antenna 308. The radio communication apparatus 300 is associated with the communication apparatus 40 illustrated in FIG. 2.

The digital baseband unit 301 generates a digital baseband signal. The DAC 303 converts an orthogonally modulated baseband signal from a digital signal into an analog signal. The digital baseband unit 301 is associated with the digital baseband unit 111 illustrated in FIG. 19. The DAC 303 is associated with the DAC 126 illustrated in FIG. 19.

The analog vector decomposer 304 converts a signal input from the DAC 303 into one set of outphasing signals S₁ and S₂. An analog vector decomposer having a similar configuration to that of the analog vector decomposer 172 described in the first example embodiment can be used for the analog vector decomposer 304. Alternatively, an analog vector decomposer having a similar configuration to that of the analog vector decomposer 172a described in the second example embodiment may be used for the analog vector decomposer 304. The analog vector decomposer 304 is associated with the vector decomposer 41 illustrated in FIG. 2. Further, the analog vector decomposer 304 is associated with the analog vector decomposer 127 illustrated in FIG. 19.

The amplifiers 305 and 306 are a power amplifier. The amplifiers 305 and 306 amplify the outphasing signals S₁ and S₂. The combiner 307 combines the amplified outphasing signals S₁ and S₂. The signal combined by the combiner 307 is a signal that reproduces the input signal of the analog vector decomposer 304. The antenna 308 emits the combined signal. The amplifiers 305 and 306 are associated with the first amplifier 42 and the second amplifier 43 illustrated in FIG. 2. The combiner 307 is associated with the combiner 44 illustrated in FIG. 2.

Note that, when an analog vector decomposer having a similar configuration to that of the analog vector decomposer 172a described in the second example embodiment is used for the analog vector decomposer 304, the digital baseband unit 301 preferably includes a correction circuit 302. The correction circuit 302 corrects a digital baseband signal in such a way that an amplitude of a signal combined by the combiner 307 is the same as an amplitude when the outphasing signals S₁ and S₂ are combined. In this way, signal accuracy can be improved.

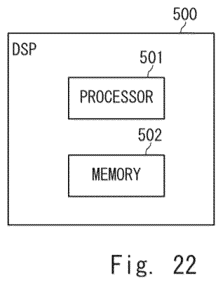

FIG. 22 illustrates a hardware configuration of a DSP that may be used in the digital baseband unit 111. A DSP 500 includes one or more processors 501 and one or more memories 502. In the DSP 500, the one or more processors 501 perform baseband signal processing by reading a program stored in the one or more memories 502, and performing the processing in accordance with the read program.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a Compact Disc (CD), a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### [Supplementary Note 1]

A vector decomposer including:
a phase rotation signal generator configured to generate a first phase rotation signal and a second phase rotation signal each having a phase rotated through 90° in a positive direction and a negative direction with respect to an input signal; and
a combiner configured to combine the input signal and the first phase rotation signal and generate a first outphasing signal, and combine the input signal and the second phase rotation signal and generate a second outphasing signal.

### [Supplementary Note 2]

The vector decomposer according to supplementary note 1, wherein the phase rotation signal generator includes a phase rotator configured to generate the first phase rotation signal by rotating a phase of the input signal through 90°, and an inversion signal generator configured to generate the second phase rotation signal by inverting a sign of the first phase rotation signal.

### [Supplementary Note 3]

The vector decomposer according to supplementary note 2, further including an amplitude adjuster configured to adjust, in accordance with an amplitude of the input signal, an amplitude of the first phase rotation signal being input to the inversion signal generator.

### [Supplementary Note 4]

The vector decomposer according to supplementary note 2, further including an amplitude fixer configured to set, to a fixed amplitude, an amplitude of the first phase rotation signal being input to the inversion signal generator.

### [Supplementary Note 5]

An optical radio transmission system including:
a base unit; and
a remote unit connected to the base unit via an optical transmission path, wherein
the remote unit includes
   an antenna, and
   a vector decomposer including a phase rotation signal generator configured to generate a first phase rotation signal and a second phase rotation signal each having a phase rotated through 90° in a positive direction and a negative direction with respect to an input signal being a reception signal received by using the antenna, and a combiner configured to combine the input signal and the first phase rotation signal and generate a first outphasing signal, and combine the input signal and the second phase rotation signal and generate a second outphasing signal, and
the base unit includes
   a combiner configured to combine the first outphasing signal and the second outphasing signal being received from the remote unit via the optical transmission path, and regenerate a signal corresponding to the reception signal,
   an analog digital converter configured to convert the regenerated signal from an analog signal into a digital signal, and
   a signal processing circuit configured to perform signal processing on the signal that has been converted into the digital signal.

### [Supplementary Note 6]

The optical radio transmission system according to supplementary note 5, wherein the phase rotation signal generator includes a phase rotator configured to generate the first phase rotation signal by rotating a phase of the input signal through 90°, and an inversion signal generator configured to generate the second phase rotation signal by inverting a sign of the first phase rotation signal.

### [Supplementary Note 7]

The optical radio transmission system according to supplementary note 6, wherein the remote unit further includes an amplitude adjuster configured to adjust, according to an amplitude of the input signal, an amplitude of the first phase rotation signal being input to the inversion signal generator.

### [Supplementary Note 8]

The optical radio transmission system according to supplementary note 6, wherein the remote unit further includes an amplitude fixer configured to set, to a fixed amplitude, an amplitude of the first phase rotation signal being input to the inversion signal generator.

### [Supplementary Note 9]

The optical radio transmission system according to supplementary note 8, wherein the signal processing circuit includes a first correction circuit configured to correct, in accordance with an amplitude of a signal corresponding to the regenerated reception signal, and the predetermined amplitude, an amplitude of the signal corresponding to the regenerated reception signal.

### [Supplementary Note 10]

The optical radio transmission system according to any one of supplementary notes 5 to 9, wherein
the base unit further includes a vector decomposer including a phase rotation signal generator configured to generate a first phase rotation signal and a second phase rotation signal each having a phase rotated through 90° in a positive direction and a negative direction with respect to an input signal being a transmission signal, and a combiner configured to combine the input signal and the first phase rotation signal and generate a first outphasing signal, and combine the input signal and the second phase rotation signal and generate a second outphasing signal, and
the remote unit further includes a combiner configured to combine the first outphasing signal and the second outphasing signal being received from the base unit via the optical transmission path, and regenerate a signal corresponding to the transmission signal.

### [Supplementary Note 11]

The optical radio transmission system according to supplementary note 10, wherein the phase rotation signal generator of the base unit includes a phase rotator configured to generate the first phase rotation signal by rotating a phase of the transmission signal being the input signal through 90°, and an inversion signal generator configured to generate the second phase rotation signal by inverting a sign of the first phase rotation signal.

[Supplementary Note 12]

The optical radio transmission system according to supplementary note 11, wherein the base unit further includes an amplitude adjuster configured to adjust, in accordance with an amplitude of the input signal, an amplitude of the first phase rotation signal being input to the inversion signal generator.

[Supplementary Note 13]

The optical radio transmission system according to supplementary note 11, wherein the base unit further includes an amplitude fixer configured to set, to a fixed amplitude, an amplitude of the first phase rotation signal being input to the inversion signal generator.

### [Supplementary Note 14]

The optical radio transmission system according to supplementary note 13, wherein the signal processing circuit includes a second correction circuit configured to correct, in accordance with an amplitude of the transmission signal and the predetermined amplitude, an amplitude of the transmission signal being input to the vector decomposer.

### [Supplementary Note 15]

A communication apparatus including:
a vector decomposer including a phase rotation signal generator configured to generate a first phase rotation signal and a second phase rotation signal each having a phase rotated through 90° in a positive direction and a negative direction with respect to an input signal being a transmission signal, and a combiner configured to combine the input signal and the first phase rotation signal and generate a first outphasing signal, and combine the input signal and the second phase rotation signal and generate a second outphasing signal;
a first amplifier and a second amplifier configured to amplify the first outphasing signal and the second outphasing signal, respectively; and
a combiner configured to combine the amplified first outphasing signal and the amplified second outphasing signal.

### [Supplementary Note 16]

The communication apparatus according to supplementary note 15, wherein the phase rotation signal generator includes a phase rotator configured to generate the first phase rotation signal by rotating a phase of the transmission signal being the input signal through 90°, and an inversion signal generator configured to generate the second phase rotation signal by inverting a sign of the first phase rotation signal.

### [Supplementary Note 17]

The communication apparatus according to supplementary note 16, further including an amplitude adjuster configured to adjust, in accordance with an amplitude of the input signal, an amplitude of the first phase rotation signal being input to the inversion signal generator.

### [Supplementary Note 18]

The communication apparatus according to supplementary note 16, further including an amplitude fixer configured to set, to a fixed amplitude, an amplitude of the first phase rotation signal being input to the inversion signal generator.

### [Supplementary Note 19]

The communication apparatus according to supplementary note 18, further including a signal processing circuit including a correction circuit configured to correct, in accordance with an amplitude of the transmission signal and the predetermined amplitude, an amplitude of the transmission signal being input to the vector decomposer.

### [Supplementary Note 20]

A vector decomposition method including:
generating a first phase rotation signal and a second phase rotation signal each having a phase rotated through 90° in a positive direction and a negative direction with respect to an input signal; and
combining the input signal and the first phase rotation signal and generating a first outphasing signal, and combining the input signal and the second phase rotation signal and generating a second outphasing signal.

A part or the whole of the elements (for example, the configuration and the functions) described in supplementary note 2 to supplementary note 4 subordinate to supplementary note 1 may also be subordinate to supplementary note 20 in a similar subordinate relationship among supplementary note 2 to supplementary note 4. A part or the whole of the elements described in any supplementary note may be applied to various types of hardware, software, recording means for recording software, systems, and methods.

What is claimed is:

1. A vector decomposer comprising:
a phase rotation signal generator configured to generate a first phase rotation signal and a second phase rotation signal each having a phase rotated through 90° in a positive direction and a negative direction with respect to an input signal; and
a combiner configured to combine the input signal and the first phase rotation signal and generate a first outphasing signal, and combine the input signal and the second phase rotation signal and generate a second outphasing signal.

2. The vector decomposer according to claim 1, wherein the phase rotation signal generator includes a phase rotator configured to generate the first phase rotation signal by rotating a phase of the input signal through 90°, and an inversion signal generator configured to generate the second phase rotation signal by inverting a sign of the first phase rotation signal.

3. The vector decomposer according to claim 2, further comprising an amplitude adjuster configured to adjust, in accordance with an amplitude of the input signal, an amplitude of the first phase rotation signal being input to the inversion signal generator.

4. The vector decomposer according to claim 2, further comprising an amplitude fixer configured to set, to a fixed amplitude, an amplitude of the first phase rotation signal being input to the inversion signal generator.

5. An optical radio transmission system comprising:
a base unit; and
a remote unit connected to the base unit via an optical transmission path, wherein
the remote unit includes
an antenna, and
a vector decomposer including a phase rotation signal generator configured to generate a first phase rotation signal and a second phase rotation signal each having a phase rotated through 90° in a positive direction and a negative direction with respect to an input signal being a reception signal received by using the antenna, and a combiner configured to combine the input signal and the first phase rotation signal and generate a first outphasing signal, and combine the input signal and the second phase rotation signal and generate a second outphasing signal, and
the base unit includes
a combiner configured to combine the first outphasing signal and the second outphasing signal being received from the remote unit via the optical transmission path, and regenerate a signal corresponding to the reception signal,
an analog digital converter configured to convert the regenerated signal from an analog signal into a digital signal, and
a signal processor configured to perform signal processing on the signal that has been converted into the digital signal.

6. The optical radio transmission system according to claim 5, wherein the phase rotation signal generator includes a phase rotator configured to generate the first phase rotation signal by rotating a phase of the input signal through 90°, and an inversion signal generator configured to generate the second phase rotation signal by inverting a sign of the first phase rotation signal.

7. The optical radio transmission system according to claim 6, wherein the remote unit further includes an amplitude adjuster configured to adjust, in accordance with an amplitude of the input signal, an amplitude of the first phase rotation signal being input to the inversion signal generator.

8. The optical radio transmission system according to claim 6, wherein the remote unit further includes an amplitude fixer configured to set, to a fixed amplitude, an amplitude of the first phase rotation signal being input to the inversion signal generator.

9. The optical radio transmission system according to claim 8, wherein the signal processor corrects, in accordance with an amplitude of a signal corresponding to the regenerated reception signal, and the predetermined amplitude, an amplitude of the signal corresponding to the regenerated reception signal.

10. The optical radio transmission system according to claim 5, wherein
the base unit further includes a vector decomposer including a phase rotation signal generator configured to generate a third phase rotation signal and a fourth phase rotation signal each having a phase rotated through 90° in a positive direction and a negative direction with respect to an input signal being a transmission signal, and a combiner configured to combine the input signal and the third phase rotation signal and generate a third outphasing signal, and combine the input signal and the fourth phase rotation signal and generate a fourth outphasing signal, and
the remote unit further includes a combiner configured to combine the third outphasing signal and the fourth outphasing signal being received from the base unit via the optical transmission path, and regenerate a signal corresponding to the transmission signal.

11. The optical radio transmission system according to claim 10, wherein the phase rotation signal generator of the base unit includes a phase rotator configured to generate the third phase rotation signal by rotating a phase of the transmission signal being the input signal through 90°, and an inversion signal generator configured to generate the fourth phase rotation signal by inverting a sign of the third phase rotation signal.

12. The optical radio transmission system according to claim 11, wherein the base unit further includes an amplitude adjuster configured to adjust, in accordance with an amplitude of the input signal, an amplitude of the third phase rotation signal being input to the inversion signal generator.

13. The optical radio transmission system according to claim 11, wherein the base unit further includes an amplitude fixer configured to set, to a fixed amplitude, an amplitude of the third phase rotation signal being input to the inversion signal generator.

14. The optical radio transmission system according to claim 13, wherein the signal processor corrects, in accordance with an amplitude of the transmission signal and the predetermined amplitude, an amplitude of the transmission signal being input to the vector decomposer.

15. A vector decomposition method comprising:
generating a first phase rotation signal and a second phase rotation signal each having a phase rotated through 90° in a positive direction and a negative direction with respect to an input signal; and
combining the input signal and the first phase rotation signal and generating a first outphasing signal, and combining the input signal and the second phase rotation signal and generating a second outphasing signal.
